(19) United States
(12) Patent Application Publication
(10) Pub. No.: US 2016/0324170 A1
(43) Pub. Date: Nov. 10, 2016

(54) Shell Egg Pasteurization Using Radio Frequency Electromagnetic Wave Energy

(71) Applicant: National Pasteurized Eggs, Inc., Lansing, IL (US)

(72) Inventors: Hector Gregorio Lara, Plainfield, IL (US); Praveena Munukuru, Plainfield, IL (US); Daniel A. Vega Martinez, Chicago, IL (US)

(73) Assignee: National Pasteurized Eggs, Inc., Lansing, IL (US)

(21) Appl. No.: 15/145,925

(22) Filed: May 4, 2016

Related U.S. Application Data
(60) Provisional application No. 62/157,158, filed on May 5, 2015.

(51) Int. Cl. A23B 5/005; A23B 5/01; A23L 3/18; A23L 3/00

(52) U.S. Cl. CPC A23B 5/0052; A23L 3/001; A23B 5/01; A23L 3/185; A23V 2002/00

(57) ABSTRACT

A shell egg pasteurization system uses radio frequency electromagnetic wave energy to heat the yolk. The radio frequency energy is applied in two stages as the shell egg is rotated and moved through the electric field. The system also has a preheating oven and a downstream albumen heating oven. The combination of heat from the ovens and the radio frequency is sufficient to achieve a 5 log kill of Salmonella Enteritidis throughout the eggs.

### FIELD OF THE INVENTION

The invention pertains to pasteurizing chicken shell eggs using the radio frequency electromagnetic wave energy.

### BACKGROUND OF THE INVENTION

The FDA standard for pasteurizing chicken shell eggs is a thermal treatment that is validated for achieving a 5 log kill of Salmonella Enteritidis throughout the entire egg including the yolk and the albumen. A D-value (measured in minutes) is the amount of time that it takes to statistically achieve a ten-fold reduction (i.e. a log reduction), of a pathogen (e.g., Salmonella Enteritidis) in a substance held at a certain temperature. D-values for Salmonella Enteritidis are known to be higher in egg yolk than in albumen, which means that it is more difficult to kill Salmonella Enteritidis in the egg yolk than in albumen. Shell egg pasteurization system using heated water baths are based in part on the notion that heating a shell egg in the water bath requires heat to transfer through the shell and through the albumen to the yolk, so the temperature of the albumen will necessarily be greater than the temperature of the yolk when the egg is coming up to the temperature of the water bath. According to current FDA requirements, the yolk temperature and the albumen temperature must be at least 128° F. before Salmonella Enteritidis is killed reliably.

The Davidson '538 patent (U.S. Pat. No. 6,165,538) provides a statistically derived line plotting the 5 D-value (i.e., five times the D-value) for shell eggs inoculated with Salmonella Enteritidis having yolk temperatures from 128° F. to 138.5° F. As the egg yolk heats from 128° F. to the water bath temperature, the log reduction accumulates and continues to accumulate as the yolk is maintained at or near the water bath temperature. In fact, log reduction continues to accumulate even after the shell egg is removed from the pasteurization bath until the yolk temperature drops below 128° F.

Present day commercial scale shell egg pasteurization facilities use large heated water baths to gently warm stacks of eggs sufficiently to achieve the required 5 log kill of Salmonella Enteritidis. These large heated water bath systems are sometimes not practical. For example, maintaining large heated water baths at the precise temperature needed for accurate pasteurization is not practical in low volume or variable volume applications. Large water baths may not be desirable in certain geographical areas with water restrictions as well. Further, pasteurization in water baths requires that the shell eggs be coated, e.g. wax, in order to replace the protective cuticle on naturally-laid shell eggs that is removed when the eggs are pasteurized in a water bath. In fact, many countries in Europe do not allow shell eggs to be washed or pasteurized in water baths because they do not want the cuticle removed.

One of the difficulties with pasteurizing shell eggs in a heated water bath is that the heat, as mentioned, is conducted through the shell and through the albumen before it is available to heat the yolk. Thus, the albumen typically receives a harsher thermal treatment than the yolk even though Salmonella Enteritidis is much easier to kill in the albumen than the yolk of the shell egg. D-values for Salmonella Enteritidis for yolk in a shell egg at 134° F. is about 7 minutes, whereas the D-value for albumen at 134° F. is about 0.7 minutes. The D-value of Salmonella Enteritidis in albumen at 132° F. is 1.25 minutes, which is still less than the D-value for the yolk at 134° F. International Egg Pasteurization Manual, Froning et al., July 2002, page 9. In other words, approved methods for egg white pasteurization require about 3.5 minutes at 134° F. and 6.2 minutes at 132° F. (to achieve at least a 5 log kill), and kill values are higher if albumen pH increases with storage time before pasteurization.

If the albumen is overheated it will begin to denature and cross link, which in turn results in cloudiness and increased whipping time for the egg white to reach full whip peak. Further overheating will lead to coagulation. Therefore, when pasteurizing in heated water baths, great care is taken to ensure that the yolks of the eggs are heated sufficiently to achieve the required 5 log kill of Salmonella Enteritidis while at the same time not overheating the eggs which can lead to lower quality albumen.

Others in the art have attempted to pasteurize chicken shell eggs using radio frequency electromagnetic wave energy with limited success. One of the more difficult problems in using radio frequency electromagnetic wave energy in the past has been the difficulty of achieving uniform heating and not overcooking and causing coagulation in the albumen. Dev et al. published a paper in 2012 entitled “Optimization of Radio Frequency of In-Shell Eggs Through Finite Element Modeling and Experimental Trials”, Progress in Electromagnetics Research B, Volume 45, 203-222, 2012 that discussed the testing and modeling of the heating of an artificial chicken egg with radio frequency electromagnetic waves for the purpose of pasteurization. The artificial egg was modelled to be a glass egg filled with egg white or albumen. The modeling was verified using a computer-controlled parallel plate radio frequency wave applicator (27.12 MHz) using an actual artificial glass egg filled with egg white. Dev et al., page 212, found that heating in a parallel plate RF applicator was highly non-uniform if the eggs were kept static between the plates, which would lead to the generation of hot spots and cold spots throughout the egg. Dev et al. found on page 2013 that the closer the static egg is to the electrodes, the faster the egg white is heated as compared to the egg yolk which would likely lead to increased coagulation of the egg white proteins. Dev et al. also found on page 2014 that rotating the artificial eggs between the electrodes led to more uniform heating and preferentially faster heating of the area in which the yolk is located than the albumen, as is preferred for pasteurization of actual shell eggs. Dev et al. does not model shell eggs with distinct yolk and albumen components or make any findings regarding the requirements for achieving a 5 log kill of Salmonella Enteritidis in the yolk or in the albumen.

U.S. Pat. No. 8,973,492, entitled “Method and Apparatus for Pasteurizing Shell Eggs Using Radio Frequency Heating” issuing on Mar. 10, 2015 to Geveke et al. applies 60 MHz radio frequency energy by placing electrodes in contact with opposite sides of a rotating shell egg. One or both of the electrodes comprises a brush or mesh. Geveke et al. also run cooling water over the shell to cool the albumen from overheating and preferentially heat the yolk. Geveke et al. explains that the penetration depth of radio frequency energy increases as frequency decreases, so RF energy having a frequency in the range of 10 MHz-100 MHz should heat the yolk better than microwave energy.

It is believed that contacting the shells with electrodes at commercial scale pasteurization facilities may lead to production difficulties. It is also believed that contacting the shells with electrodes may compromise the integrity of the shells, and lead to breakage or premature contamination issues. Therefore, one of the objects of the present invention is to pasteurize shell eggs without contacting the shell with the electrodes.

Another object is to provide a system that does not require the use of water. Shell egg water bath pasteurization technology is more than adequate for large scale operations where water usage is not an issue. Where water conservation is a priority, a waterless shell egg pasteurization system may be more practical and commercially favorable.

### SUMMARY OF THE INVENTION

The invention is directed to methods for pasteurizing chicken shell eggs using radio frequency electromagnetic wave energy to heat the yolk preferably without the use of water.

The dielectric loss factor (∈″) is higher for albumen than for yolk, which means that the albumen will more readily absorb radio frequency energy than the yolk. Nevertheless, because the yolk is located in the center of the egg, the yolk tends to heat faster than the albumen when the egg is rotated with respect to the electric field. In the present invention, the radio frequency electromagnetic wave energy is applied while the eggs are on their side and rotating on rollers while the shell eggs are located between the electrodes. The rollers should be made of a material that does not affect the electric field such as high density polyethylene. A challenge in scaling up a radio frequency shell egg pasteurization process to production levels is achieving uniform heating temperature among the yolks in the large number of shell eggs being pasteurized. The inventors have addressed this issue in several ways. First, the inventors have discovered that it is helpful to move the rotating eggs longitudinally and perpendicularly between the plates while the RF energy is applied.

Second, the radio frequency electromagnetic wave energy is applied in two or more stages in which frequency and/or electric field strength are adjusted to ensure that the yolk temperature does not spike above the desired temperature range for pasteurization (140° F. to 145° F.) In the first stage, the energy may be applied at a frequency (e.g., 27.12 MHz) and electric field strength that efficiently heats the yolk but does not significantly heat the shell, the albumen or other parts of the eggs, e.g. chalaza. A frequency of 27.12 MHz is well suited to provide a uniform electric field across flat plate electrodes. As RF frequency increase, nodes in the electric field are more likely to occur between the plates. It is therefore desirable to use a frequency below about 30-40 MHz. A frequency of 27.12 MHz is also desirable for production scale systems because 27.12 MHz systems are commercially available with sufficient power to meet the heating loads of production scale systems. The voltage between the plates of the RF applicator is regulated, and the electric field strength is typically adjusted by changing the distance between the plates. Energy absorbed is directly proportional to the dielectric loss factor (∈″) and frequency, and exponentially proportional to electric field strength (E²). Therefore, the amount of time to heat the yolk for a given temperature change can be reduced significantly by moving the electrodes closer. On the other hand, setting the electrodes farther apart reduces the rate of energy absorption. Therefore, in accordance with one aspect of the invention, energy is applied at the first stage at a frequency and electric field strength designed to raise the temperature of the yolk to a preselected yolk pasteurization temperature. In the second stage, the energy is applied at either a frequency less than in the first stage or with a weaker electric field in order to maintain the temperature of the yolk at or above the predetermined yolk pasteurization temperature without continuing to raise the yolk temperature above a maximum desired yolk pasteurization temperature. In one embodiment of the invention, the eggs are conveyed through the radio frequency energy applicator preferably on the rollers described above. In the first stage, at 27.12 MHz radio frequency electromagnetic wave energy is applied with the eggs located between parallel plate electrodes. In the second stage, at least one of the parallel plate electrodes is tilted so that the electric field strength decreases as the eggs move through the second stage. Since the shell eggs are rotated as they move through the RF applicator, the yolk absorbs more heat and obtains a higher temperature than the albumen. For example, the yolk can be heated to about 145° F. without noticeably compromising the quality of the yolk. At 145° F., even for a short amount of time, the albumen would coagulate. The advantage of heating the yolk to 145° F. is that the D-value is about 0.45 minutes which means that a full 5-log reduction of Salmonella Enteritidis can occur in less than 2.5 minutes. For the first stage of applying RF energy, the temperature of the yolk should increase to about 145° F. quickly and uniformly in less than 2 minutes. The electric field strength is then decreased in the second stage to lower the amount of energy absorbed by the yolk in order to maintain the temperature of the yolk without further increasing the temperature. This is important for at least two reasons. First, the quality of the yolk can be damaged if the temperature is raised too much above 145° F. Second, if the temperature of the yolk is too high for too long, heat transfer from the yolk will start to coagulate the albumen.

It has also been found desirable to preheat the eggs at, for example 110° F. to 120° F., prior to applying the RF energy to heat the yolks. By preheating the eggs to 120° F., the albumen in the eggs remain substantially unaffected yet the come-up time in the radio frequency applicator is shorter and more efficient thereby providing for more uniformity in heating the egg yolks. Desirably, the preheating occurs in a hot air oven for about 10-15 minutes or less. It may be desirable to preheat the shell eggs in a convection oven set substantially higher than 120° F. in order to accelerate the preheating phase.

After the yolks of the eggs are heated to the preselected pasteurization temperature, e.g. between 140° F. to 150° F. and preferably about 145° F., with the RF energy, the eggs are placed, by conveyor, into an albumen heating environment such as another hot air oven. In one exemplary embodiment of the invention the compartment in which the RF energy is applied, is also an oven. In this way the albumens of the shells in the compartment with the RF applicator are heated similarly to how they are heated in the albumen heating hot air oven, and this reduces the amount of time needed in the albumen heating hot air oven. The albumen heating hot air oven (and if applicable the RF compartment) has a temperature set at a preselected albumen pasteurization temperature, e.g., preferably between 130 to 132° F.; however, it is contemplated that the albumen heating hot air oven can be set at a higher temperature such as 135° F. The eggs are conveyed through the albumen heating hot air oven and are held in that environment for an amount of time sufficient to achieve at least a 5-log kill of Salmonella Enteritidis in the albumen. As mentioned, the D-value for the albumen is much less for a given temperature than for the yolk. For example, as mentioned, the D-value of albumen at 132° F. is about 1.25 minutes. Therefore if the albumen hot air oven is held at 132° F. (and the albumen is maintained at 132° F.), the shell eggs must be held in the oven for 6.25 minutes in order to achieve a 5-log kill of Salmonella Enteritidis in the albumen. As mentioned, the pasteurization process continues in the yolk as long as the temperature of the yolk is maintained above 128° F. Therefore, the accumulation of Salmonella Enteritidis kill in the yolk while the egg is held in the albumen heating hot air oven should also be considered and will reduce the length of heating required in the radio frequency electromagnetic wave energy applicator. In other words, the shell eggs should be held within the albumen heating hot air oven for an amount of time not only sufficient to achieve at least a 5-log kill of Salmonella Enteritidis in the albumen but also sufficient that the combination of heating the yolk with the radio frequency electromagnetic wave energy and holding the shell egg in the albumen heating hot air oven achieves a 5 log kill of Salmonella Enteritidis in the yolk.

One of the advantages of the method described is that it enables pasteurization of chicken shell eggs without the use of water and in a time efficient manner. Further, because relatively low oven temperatures are used, the albumen does not become cloudy or at least significantly cloudy, e.g. 200 nephelometric turbidity units or less. Another advantage of the system is that the pasteurization equipment can be run intermittently and is therefore well-suited for applications with relatively small volumes such as pasteurization operations on the farm site.

### BRIEF DESCRIPTION OF THE DRAWINGS

FIG. 1 is a block diagram showing the overall process for pasteurizing chicken shell eggs using radio frequency wave energy.

FIG. 2 is a graph illustrating the temperature of the yolk during the pasteurization process illustrated in FIG. 1.

FIG. 3 is a graph illustrating the temperature of the albumen during the pasteurization process illustrated in FIG. 1.

FIG. 4 is a side view of an exemplary embodiment of an in-line pasteurizer constructed in accordance with the invention.

FIG. 5 is a top plan view of the in-line pasteurizer illustrated in FIG. 4.

FIG. 6 is a sectional view of the in-line pasteurizer taken along line 6-6 in FIG. 5.

### DETAILED DESCRIPTION

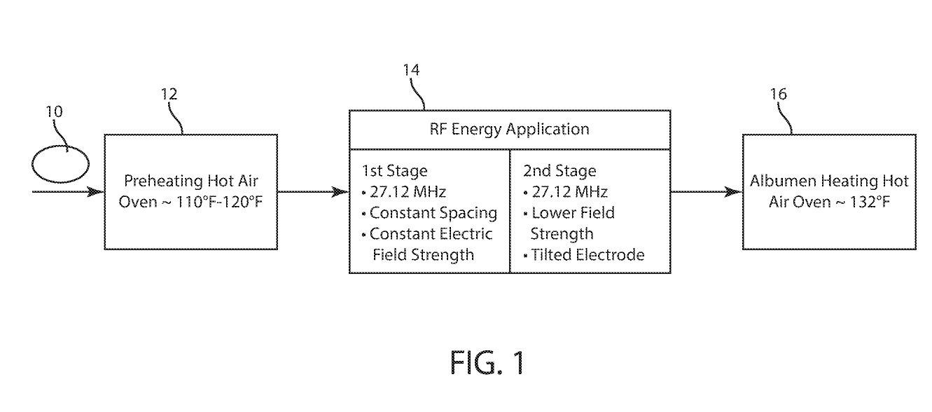

FIG. 1 is a flow chart illustrating an exemplary embodiment of the invention. Prior to pasteurization, the chicken shell egg or a plurality of chicken shell eggs are desirably tempered to about 65° F. Alternatively, the eggs can be refrigerated at for example 45° F. If multiple eggs are to be pasteurized, it is desirable that all of the eggs be tempered or refrigerated to the same temperature prior to the pasteurization process. Block 12 represents a preheating hot air oven that is maintained at approximately 120° F. The egg 10 or multiple shell eggs 10 are placed in the preheating hot air oven 12 so that the eggs are preheated throughout to a temperature in the range of 110° F. to 120° F. Preheating should take approximately 5 to 15 minutes depending on the initial start temperature of the eggs 10. The purpose of preheating is to increase the temperature of the yolk so that heating downstream with radio frequency electromagnetic wave energy is more efficient, more effective and more uniform. It is also believed that removing humidity improves the uniformity of RF heating in the next step of the process. At 120° F., the quality of the albumen should be substantially unaffected as measured by the cloudiness and albumen whipping time compared to a raw egg. The egg 10 or multiple eggs are preferably passed into and through the preheating hot air oven 12, then through the radio frequency energy applicator 14, and then through an albumen heating hot air oven 16. While the purpose of the preheating hot air oven 12 is to preheat the egg throughout to a uniform temperature, the purpose of the radio frequency energy applicator 14 is to heat the yolk and the purpose of the albumen heating hot air oven is to heat the albumen. The radio frequency energy applicator 14 includes two flat plate electrodes with the egg or eggs 10 being located between the electrodes on rollers. As mentioned above, the rollers are made of a material that does not affect the electromagnetic field such as HDPE. The egg or eggs 10 are laid horizontally and turned by the rollers. The rollers oscillate slowly in the longitudinal and perpendicular directions while the egg or eggs are located in the radio frequency energy applicator. As mentioned, the RF energy applicator preferably includes two stages. In the first stage, the parallel plate electrodes are maintained at a constant spacing and energy is applied at, for example 27.12 MHz, with a fixed electric field strength. The specific frequency and electric field strength is chosen to adequately heat the yolk compared to the albumen as well as provide an adequately uniform electric field between the plates. The oscillation of the rotating eggs in the longitudinal and/or perpendicular directions also helps the eggs be exposed to a uniform amount of RF energy while in the applicator. The application of energy in the first stage quickly brings the temperature of the yolk up to a preselected yolk pasteurization temperature, e.g. about 145° F. The preselected yolk pasteurization temperature should be between 140° F. to 150° F. to achieve best overall results. As mentioned, at 145° F. the quality of the yolk is not noticeably compromised yet the D-value is about 0.45 minutes which means that the yolk will obtain a 5 log kill in less than 2.5 minutes. In the second stage, the distance between the plate electrodes is greater which means that the electric field strength is lower and the energy available to be absorbed by the yolk is also lower. This is important so that the yolk does not continue to heat substantially after it reaches the preselected yolk pasteurization temperature. The application of energy during the second stage maintains the temperature of the yolk without increasing the temperature, at least substantially. The total time for the egg in the RF energy applicator in this example is 5 minutes with about 2 minutes in the first stage and about 3 minutes in the second stage.

The eggs are then conveyed from the RF energy applicator 14 to the albumen heating hot air oven 16. The albumen heating hot air oven is desirably maintained at about 132° F. The purpose of the albumen heating hot air oven is to heat the albumen to and maintain the albumen at a preselected albumen pasteurization temperature for a preselected amount of time in order to achieve at least a 5 log kill of Salmonella Enteritidis in the albumen. The D-value for Salmonella Enteritidis in albumen at 132° F. is about 1.25 minutes. Therefore, the time that the eggs should be in the albumen heating hot air oven 16 is approximately 6-8 minutes.

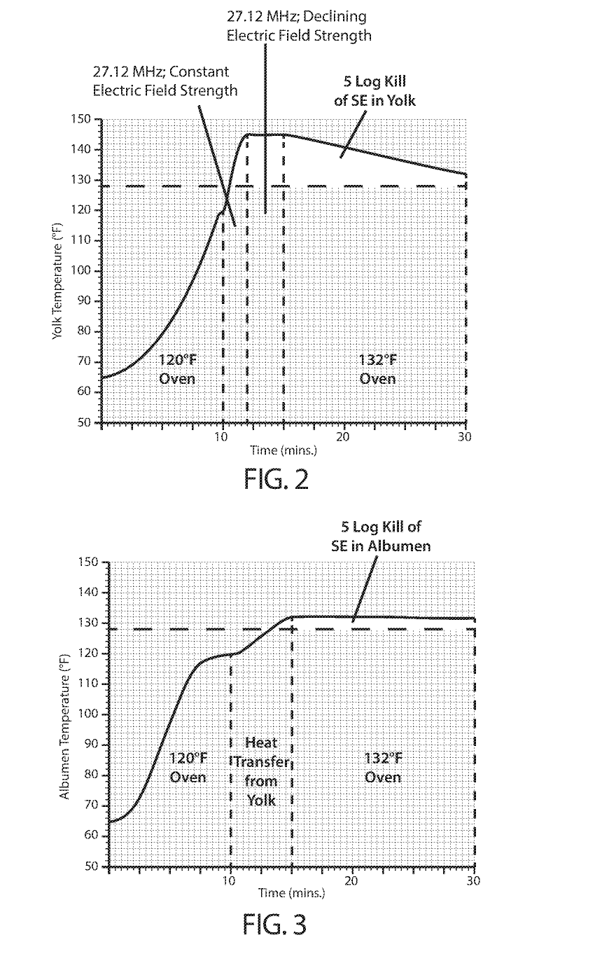

FIG. 2 is a plot schematically illustrating how the yolk temperature varies with respect to the overall time in the pasteurization process set forth in FIG. 1. At time 0 minutes in FIG. 2, the eggs are placed in the preheating hot air oven 12. FIG. 2 shows the eggs being in the hot air oven for 10 minutes. The temperature of the egg yolk in FIG. 2 begins at 65° F. After a short period of time, the temperature rises to 120° F. in equilibrium with the preheating oven temperature. It is not strictly necessary for the yolk temperature to be raised to the temperature of the preheating hot air oven in order to implement other aspects of the invention. It is desirable that the eggs be heated to a substantially uniform temperature, however, prior to applying RF energy. At the 10 minute mark in FIG. 2, the egg is conveyed into the first stage of the RF energy applicator 14. Radio frequency electromagnetic wave energy is applied at for example 27.12 MHz to heat the yolk for a predetermined time necessary to heat the egg yolk to 145° F. In FIG. 2, this time is shown to be 2 minutes. At the 2 minute mark, the egg passes into the second stage of the RF energy applicator 14 during which time RF energy is applied by a declining electric field as the egg continues to pass through the second stage. The temperature is maintained with this declining electric field in the second stage at or above the 145° F. temperature. Then at the 15 minute mark in FIG. 2 the egg is conveyed into the albumen heating hot air oven 16 held at about 132° F. While in the albumen heating hot air oven 16, the temperature of the yolk declines steadily to the 132° F. mark. For all times above the 128° F. line in FIG. 2, log kill of Salmonella Enteritidis accumulates in the yolk during the pasteurization process. While it may be desirable to achieve the 5 log kill of Salmonella Enteritidis in the yolk during the application of RF energy to the egg yolk, a significant amount of log kill can accumulate in the yolk while the egg is in the albumen heating hot air oven 16. Therefore, it may be desirable to kill, for example, 3 log while the egg is in the RF energy applicator 14 and kill the additional 2 log while the egg is located in the albumen heating hot air oven 16.

FIG. 3 illustrates the albumen temperature as the egg passes through the process illustrated in FIG. 1. The albumen begins at 65° F. at time 0 minutes which is the time the egg or eggs are placed in the preheating hot air oven 12. The temperature of the albumen increases to about 120° F. at about the 8 minute mark and remains at 120° F. in equilibrium with the preheating hot air oven 12. Then the egg or eggs are transferred to the RF energy applicator 14. While the egg is in the RF energy applicator 14, heat is transferred from the yolk to the albumen and also some heat may be absorbed from the radio frequency electromagnetic waves. In any event, testing has shown that it is quite unlikely for the albumen temperature to rise to the point where it will harm the quality of the albumen unless RF energy is applied to the egg for too long, e.g. if RF energy is applied throughout at a very low frequency or electric field strength causing it to take too much time to bring the yolk up to temperature. The eggs are then passed into the albumen heating hot air oven 16 and held at 132° F. Note in FIG. 3 that the temperature of the albumen is already at about 132° F. at the time the egg enters the albumen heating hot air oven 16. Ideally, the temperature of the albumen heating oven is set between 130° F. to 132° F., but 133° F. to 135° F. should be acceptable and should not compromise the quality of the albumen too much depending on the time the egg or eggs are kept in the oven. In a short amount of time, the temperature of the albumen settles at 132° F. in equilibrium with the hot air oven 16 and the egg is held in the oven for a long enough time to achieve a 5 log kill of Salmonella Enteritidis in the albumen. FIG. 3 shows the time being 15 minutes which well exceeds the 6 to 8 minutes necessary to achieve a 5 log kill of Salmonella Enteritidis in the albumen at 132° F. The additional time, however, should not compromise the quality of the albumen because of the relatively low temperature. Keeping the egg or eggs in the albumen heating oven for 15 minutes enables the yolk to achieve more kill after the RF applicator. This in turn enables the overall process to achieve a 5 log kill in the yolk without over processing the yolk with the RF applicator.

The plots in FIGS. 2 and 3 are meant to illustrate concepts of the invention and are not plots of actual data. It may be desirable to apply RF energy 14 at the same time that the shell eggs are in an oven 16 in order to reduce overall processing time.

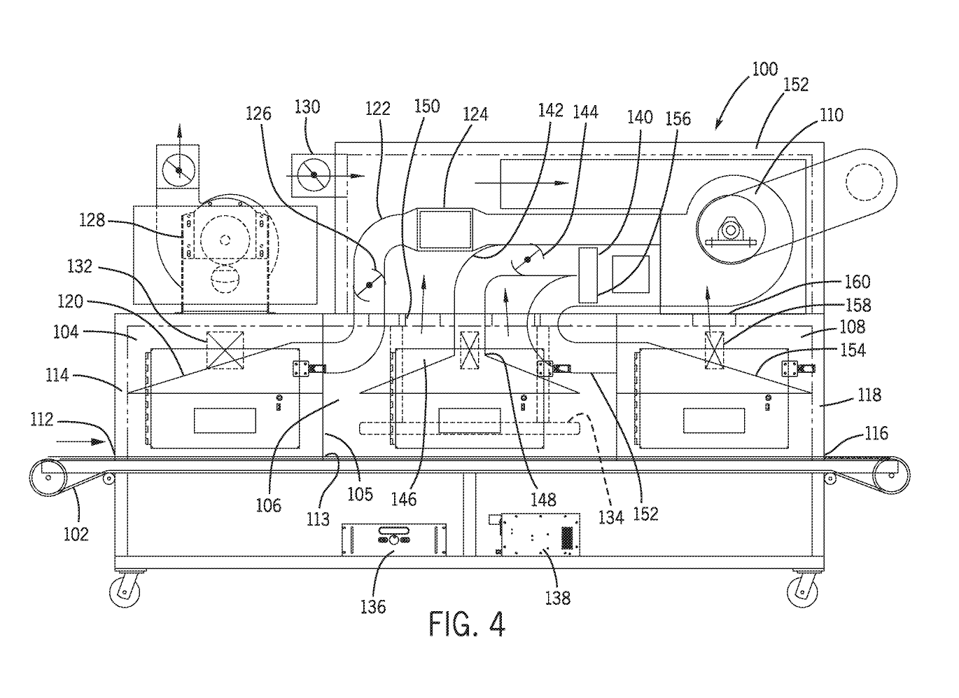

FIGS. 4 through 6 show an exemplary in-line pasteurizer 100 constructed in accordance with the concepts of the invention. The exemplary in-line pasteurizer 100 includes three independently controlled heating compartments 104, 106 and 108 and a conveyor 102 that moves a layer of multiple shell eggs through the compartments 104, 106 and 108 to heat and pasteurize the yolks and albumens of the eggs. An RF applicator is located in second compartment 106. The conveyor belt speed is adjustable, e.g., 0.25 feet to 1.0 feet per minute. The overall length of the conveyor 102 in this embodiment is roughly 12 feet. The shell eggs are placed on an open weave, polyethylene belt which rotates the eggs while the eggs move through the in-line pasteurizer 100. The polyethylene conveyor belt is driven on steel rollers with polyethylene gears. It is important that the material used for the conveyor belt does not interfere with the RF energy field of the second compartment 106.

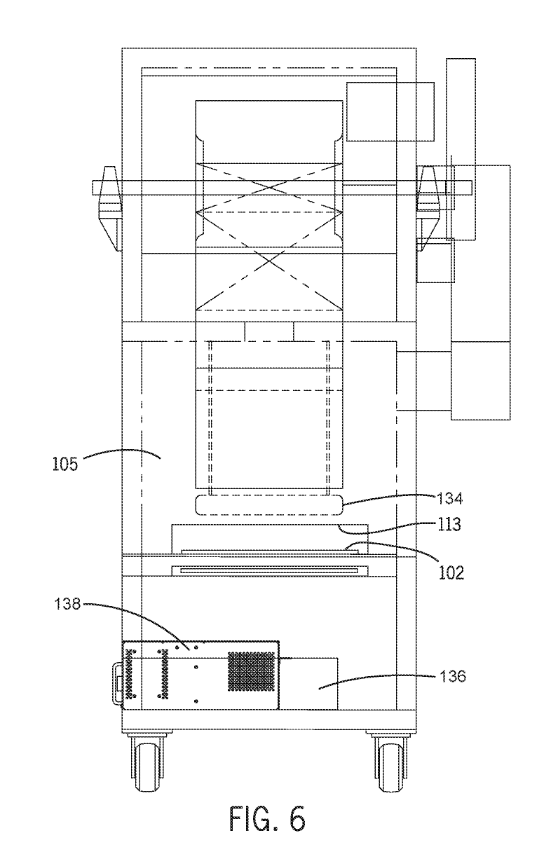

The first compartment 104 is a convection pre-heating oven. The second compartment 106 includes an RF applicator and a convection heater, and the third compartment 108 is a convection albumen heating oven. The in-line pasteurizer 100 uses a recirculation fan 110 to supply air to ducts and heaters for each compartment 104, 106 and 108 independently. The shell eggs travel on the conveyor 102 from left to right in FIG. 4, and enter the pasteurizer 100 through opening 112 in the front wall 114 of the pre-heating oven 104. The shell eggs exit the pasteurizer 100 on the conveyor 102 through an opening 116 in the rear wall of the albumen heating oven 108. FIG. 6 shows the conveyor 102 passing through opening 113 in the wall 105 between the first compartment 104 and the second compartment 106. Also, the conveyer belt 102 is designed so that the shell eggs rotate while lying on their side as the eggs are moved through the pasteurizer 100. This feature is especially important while the eggs are located in the second compartment 106 and are receiving RF energy.

Still referring to FIGS. 4 through 6, the pre-heating oven 104 is designed to raise the initial temperature of the shell eggs throughout from an ambient temperature (or a refrigerated temperature) to a temperature greater than 100° F. and desirably in the range of 110° F. to 120° F. A convection air supply vent 120 is located in the pre-heating oven 104 and receives heated air from duct 122. The recirculation fan 110 pushes air through duct 122 and through electric hot air heater 124 located in the duct 122. An air valve 126 is provided in duct 122 to adjust the amount of air flow through the duct 122 into the pre-heating oven 104. The electric hot air heater 124 in the duct 122 is desirably capable of heating the air in duct 122 to 200° F. A 27 kW electric heater 124 is sufficient for the pasteurizer depicted in FIGS. 4 through 6. An exhaust fan 128 draws air from the pre-heating oven 104 through exhaust vent 132. A make-up air valve 130 opens to provide make up air to the recirculation fan 110. One or more temperature sensors are located in the pre-heating oven for controlling the operation of the convection hot air system for the pre-heating oven 104.

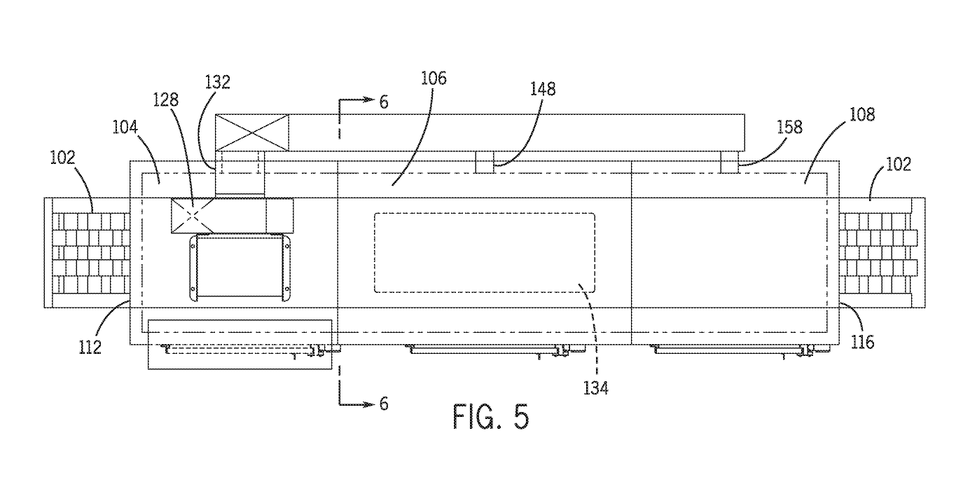

The second zone 106 is a combination RF applicator and heated hot air zone where the yolk of the eggs are heated internally with RF energy, while the albumen temperature is heated to and maintained at the target temperature, e.g., 132° F. The RF applicator consists of an electrode and matching system that enables uniform electric field heating of the conveyed eggs. The electrode 134 is located above the conveyor 102 in FIGS. 4 and 5. The electrode 134 shown in FIGS. 4 and 5 can be a two-stage system as described above, but in the exemplary embodiment shown in FIGS. 4 and 5 is a single stage system. RF power is supplied by a 27.12 MHz solid state RF generator 136 and is coupled to the electrode 134 through a 50 ohm cable and a load matching network 138. The RF power level can be controlled manually by the operator via the control panel on an RF amplifier, but it is more desirable to have the RF level controlled automatically via a preselected protocol customized for the size and number of eggs being pasteurized and the speed of the conveyor belt. The matching network 138 adjusts automatically. The height of the electrode 134 in this embodiment is manually adjustable.

The recirculation fan 110 moves air through duct 142 and an in-duct electric heater 140 into the second compartment 106 via duct supply vent 146. The duct supply vent 146 is located above the electrode 134 and the conveyor 102 and blows heat air downward on the shell eggs on the conveyor 102 in the second compartment 106. An air valve 144 is provided in duct 142 to adjust the amount of air flow through the duct 142 into the second compartment 106. The electric hot air heater 140 is desirably capable of heating the air in duct 142 to 135° F., although it will normally be operated to heat the second compartment 106 to a temperature of 132° F. in order to minimize cloudiness of the albumen in the shell eggs being pasteurized. A 4.5 kW electric heater 140 is sufficient for the pasteurizer depicted in FIGS. 4 through 6. The exhaust fan 128 draws air from the second compartment 106 through exhaust vent 148. The ceiling of the second compartment 106 includes vents 150 that lead directing into the compartment 152 housing the recirculation fan 110. One or more temperature sensors are located in the second compartment 106 for controlling the operation of the convection hot air system for the second compartment 106. The temperature in the second compartment is controlled independently of the temperature in the pre-heating oven 104.

The recirculation fan 110 also moves air through duct 152 and an in-duct electric heater 156 into the albumen heating oven 108 via duct supply vent 154. The albumen heating oven 108 is maintained at desirably at the same target temperature as the second compartment 106, e.g., 132° F. The duct supply vent 154 blows heated air downward on the shell eggs on the conveyor 102 in the albumen heating oven 108. The electric hot air heater 156 is desirably capable of heating the air in duct 152 to 135° F., although it will normally be operated to heat the albumen heating oven 108 to a temperature of 132° F. in order to minimize cloudiness of the albumen in the shell eggs being pasteurized. A 4.5 kW electric heater 156 is sufficient for the pasteurizer depicted in FIGS. 4 through 6. The exhaust fan 128 draws air from the albumen heating oven 108 through exhaust vent 158. The ceiling of the albumen heating oven 108 includes vents 160 that lead directing into the compartment 152 housing the recirculation fan 110. One or more temperature sensors are located in the albumen heating oven 108 for controlling the operation of the convection hot air system for the albumen heating oven 108. The temperature in the albumen heating oven 108 is controlled independently of the temperature in the pre-heating oven 104 and the temperature in the second compartment 106, although as mentioned it is desired that both the second compartment 106 and the albumen heating oven 108 be heated to the same target temperature. The heating loads in the different zones 104, 016 and 108 are different and therefore separate heating control is desired.

In the foregoing description, certain terms have been used for brevity, clarity, and understanding. No unnecessary limitations are to be inferred there from beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

1. A method of pasteurizing a chicken shell egg comprising the steps of:
holding a shell egg in a preheating environment to preheat the shell egg prior to heating the yolk of the shell egg in an RF energy applicator;
moving the preheated shell egg from the preheating environment into the RF energy applicator using a conveyor;
heating the yolk of a shell egg in the RF energy applicator with radio frequency electromagnetic wave energy to increase the temperature to at least a preselected yolk pasteurization temperature and continuing to heat the yolk of the shell egg in the RF energy applicator with radio frequency electromagnetic wave energy to maintain the temperature of the yolk at or above the preselected yolk pasteurization temperature for preselected amount of time, wherein the shell egg is supported on the conveyor in the absence of liquid water when the yolk of the shell egg is being heated by the radio frequency electromagnetic wave energy, the conveyor moves the shell egg between the electrodes in the RF applicator without the shell egg contacting the electrodes and the shell egg is arranged on its side on rollers on the conveyor and spins when the radio frequency electromagnetic wave energy is being applied;
placing the shell egg in an albumen heating environment having a temperature set at a preselected albumen pasteurization temperature;
holding the shell egg in the albumen heating environment for an amount of time sufficient to achieve at least a five log kill of Salmonella Enteritidis in the albumen and also sufficient to achieve a 5 log kill of Salmonella Enteritidis in yolk by a combination of heating the yolk with radio frequency electromagnetic wave energy and the holding of the shell egg in the albumen heating environment.

2. The method of pasteurizing a chicken shell egg as recited in claim 1 wherein the preheating environment is a hot air oven designed to heat the shell eggs to between 110° F. and 120° F.

3. The method of pasteurizing a chicken shell egg as recited in claim 1 when the albumen heating environment as a hot air oven held between 130° F. and 135° F.

4. The method of pasteurizing a chicken shell egg as recited in claim 3 when the albumen heating hot air oven is held between 130° F. and 132° F.

5. The method of pasteurizing a chicken shell egg as recited in claim 1 wherein the preselected yolk pasteurization temperature is between 140° F. and 150° F.

6. The method of pasteurizing a chicken shell egg as recited in claim 1 wherein the radio frequency heating occurs in two stages, where a first stage applies radio frequency electromagnetic wave energy at a first regulated electric field strength and a second stage applies radio frequency electromagnetic wave energy at a lower electric field strength than during the first stage.

7. The method of pasteurizing a chicken shell egg as recited in claim 1 wherein preheating occurs for about 10 to 15 minutes at 110° F. to 120° F., radio frequency heating occurs for about 2 to 7 minutes, and albumen heating occurs for about 6 to 18 minutes at 130° F. and 135° F.

8. (canceled)

9. The method as recited in claim 1 wherein said conveyor also oscillates longitudinally and perpendicularly when the radio frequency electromagnetic wave energy is applied.

10. The method of pasteurizing a chicken shell egg as recited in claim 1 wherein the step of heating the yolk of a shell egg with radio frequency electromagnetic wave energy to increase the temperature to at least a preselected yolk pasteurization temperature and continuing to heat the yolk of the shell egg with radio frequency electromagnetic wave energy to maintain the temperature of the yolk at or above the preselected yolk pasteurization temperature for preselected amount of time is accomplished while the shell egg is placed in an albumen heating environment comprising a hot air oven having a temperature set at a preselected albumen pasteurization temperature.

11. The method of pasteurizing multiple shell eggs comprising the steps of:
holding the shell eggs in a preheating environment to preheat the shell eggs prior to heating the yolks of the shell eggs in an RF energy applicator;
moving the preheated shell eggs from the preheating environment into the RF energy applicator using a conveyor;
heating the yolks of the shell eggs with radio frequency electromagnetic wave energy to increase the temperature to at least a preselected yolk pasteurization temperature and continuing to heat the yolks of the shell eggs with radio frequency electromagnetic wave energy to maintain the temperature of the yolks at or above the preselected yolk pasteurization temperature for a preselected amount of time, wherein the shell eggs are supported on the conveyor in the absence of liquid water when the yolks of the shell eggs are being heated by the radio frequency electromagnetic wave energy, the conveyor moves the shell eggs between the electrodes in the RF applicator without the shell eggs contacting the electrodes, and the shell eggs are arranged on their side on a rollers on the conveyor and spin as the radio frequency electromagnetic wave energy is applied;
placing the shell eggs in an albumen heating environment having a temperature set at a preselected albumen pasteurization temperature;
holding the shell eggs in the albumen heating environment for an amount of time sufficient to achieve at least a 5 log kill of Salmonella Enteritidis in the albumens and also sufficient to achieve at least a 5 log kill of Salmonella Enteritidis in the yolks by the combination of heating the yolks with radio frequency electromagnetic wave energy and holding the shell eggs in the albumen hearing environment.

12. A method of pasteurizing multiple shell eggs as recited in claim 11 wherein the radio frequency heating occurs in two stages, where a first stage applies radio frequency electromagnetic wave energy at a first regulated electric field strength and a second stage applies radio frequency electromagnetic wave energy at a lower electric field strength than during the first stage.

13. A method of pasteurizing multiple shell eggs as recited in claim 11 wherein preheating occurs for 10 to 15 minutes at 110° F. to 120° F., RF heating occurs for 2 to 7 minutes, and albumen heating occurs for 6 to 18 minutes.

14. The method of pasteurizing a chicken shell egg as recited in claim 11 wherein the step of heating the yolks of the shell eggs with radio frequency electromagnetic wave energy to increase the temperature to at least a preselected yolk pasteurization temperature and continuing to heat the yolks of the shell eggs with radio frequency electromagnetic wave energy to maintain the temperature of the yolks at or above the preselected yolk pasteurization temperature for preselected amount of time is accomplished while the shell eggs are placed in an albumen heating environment comprising a hot air oven having a temperature set at a preselected albumen pasteurization temperature.

15. A method of pasteurizing the yolk of a shell egg comprising the steps of:
heating the yolk of the shell egg in an RF applicator with radio frequency electromagnetic wave energy to increase the temperature to at least a preselected yolk pasteurization temperature and continuing to heat the yolk of the shell egg with radio frequency electromagnetic wave energy to maintain the temperature of the yolk at or above the preselected yolk pasteurization temperature for a preselected amount of time, wherein the shell egg is supported on the conveyor in the absence of liquid water when the yolk of the shell egg is being heated by the radio frequency electromagnetic wave energy, the conveyor moves the shell egg between the electrodes in the RF applicator without the shell egg contacting the electrodes and the shell egg is arranged on its side on rollers on the conveyor and spins when the radio frequency electromagnetic wave energy is being applied; and further wherein the application of radio frequency electromagnetic wave energy occurs in two stages: the first stage applies radio frequency energy at a first regulated electric field strength; and the second stage applies radio frequency energy at a lower electric field strength than during the first stage and the conveyor moves the egg through the RF applicator in order to apply energy in the first stage and subsequently in the second stage.

16. The method of pasteurizing the yolk of a shell egg as recited in claim 15 wherein RF electromagnetic wave energy is applied in an RF applicator having a lower and an upper electrode plate wherein the distance between the lower and upper electrode plate during the first stage is set at a constant distance so that RF electromagnetic wave energy is applied at a the first regulated electric field strength, and the distance between the first and second electrode plates in the second stage increases as the shell egg moves through the second stage so that the electric field strength continually lowers as the egg moves through the second stage.

17. A method of pasteurizing the yolk of a chicken shell egg as recited in claim 15 wherein the temperature of the yolk during the first stage is increased to between about 140 to 150° F. and the temperature of the yolk is maintained within plus or minus 5° F. during the second stage of RF heating.

18. (canceled)

19. The method as recited in claim 15 wherein said rollers also oscillate longitudinally and perpendicularly when the radio frequency electromagnetic wave energy is applied.

20. The method of pasteurizing the yolk of a shell egg as recited in claim 15 wherein the step of heating the yolk of a shell egg with radio frequency electromagnetic wave energy to increase the temperature to at least a preselected yolk pasteurization temperature and continuing to heat the yolk of the shell egg with radio frequency electromagnetic wave energy to maintain the temperature of the yolk at or above the preselected yolk pasteurization temperature for preselected amount of time is accomplished while the shell egg is placed in an albumen heating environment comprising a hot air oven having a temperature set at a preselected albumen pasteurization temperature.
